(19) United States
(12) Patent Application Publication
(10) Pub. No.: US 2010/0088640 A1
(43) Pub. Date: Apr. 8, 2010

(54) Method And Electrical Device For Displaying Data To A User

(75) Inventor: Robert Reay, Rochester, NY (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 12/247,943

(22) Filed: Oct. 8, 2008

(51) Int. Cl. G06F 3/048

(52) U.S. Cl. 715/828

(57) ABSTRACT

In a number of embodiments, a method of displaying data to a user includes: (a) displaying an ordered list, wherein the ordered list includes: (1) at least a first letter of a first entry of at least two entries of data; and (2) at least one character appended after the at least the first letter of the first entry of the at least two entries of the data, where the at least one character is absent from the first entry; (b) retrieving one or more second entries of the at least two entries of the data; and (c) displaying the one or more second entries of the at least two entries of the data. Other embodiments are disclosed herein.

### FIELD OF THE INVENTION

This invention relates generally to methods and devices for data retrieval and data display, and relates more particularly to methods and devices for scrolling through retrieved data.

### DESCRIPTION OF THE BACKGROUND

Due to various factors, such as limited display area, an electrical device often cannot display an entire set of data within a display area of a display unit of the electrical device For example, a set of data can be too long to be shown in its entirety. To solve this problem, an electrical device can employ scrolling to enable a user to view different portions of the set of data at different times. That is, the set of data can be scrolled to a new position such that the display unit now shows portions of the set of data that the user was previously unable to see (and correspondingly, the display no longer shows previously shown portions of the set of data).

In some situations, however, a user of an electrical device might want to scroll through the set of data faster than the electrical device can display the data on the display unit. For example, if an electrical device is wirelessly retrieving unshown portions of the set of data from a master device, the retrieval rate might be slower than the desired scrolling rate. That is, the electrical device cannot retrieve the data fast enough to keep up with the scrolling. In these situations, the electrical device will show a portion of the data, pause to retrieve the next portion of the data, and after retrieving the next portion of the data, continue the scrolling by showing the next portion of the data. Accordingly, the data does not smoothly scroll across the display unit of the electrical device. Rather, the electrical device displays the data in a “jerky” or intermittent manner. Users tend to find the “jerky” or intermittent scrolling frustrating and annoying to use.

Accordingly, a need or potential for benefit exists for an electrical device that provides a user with a better scrolling experience by allows a user to smoothly scroll through data, even when the data retrieval rate is slower than the desired scrolling rate.

### BRIEF DESCRIPTION OF THE DRAWINGS

To facilitate further description of the embodiments, the following drawings are provided in which:

FIG. 1 illustrates an overview of a system for transmitting and displaying data, according to a first embodiment;

FIG. 2 illustrates an electrical device of the system of FIG. 1 while a user is scrolling through data, according to the first embodiment;

FIG. 3 is a block diagram illustrating an example of the electrical device of FIGS. 1 and 2, according to the first embodiment;

FIG. 4 illustrates a flow chart of an example of a method of data retrieval and data display, according to the first embodiment;

FIG. 5 illustrates a flow chart of an example of an activity of initiating the electrical device of FIGS. 1-3, according to the first embodiment;

FIG. 6 illustrates a flow chart of an example of a procedure of retrieving the first set of entries in the data, according to the first embodiment; and

FIG. 7 illustrates an overview of an electrical device for transmitting and displaying data, according to a second embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “on,” as used herein, is defined as on, at, or otherwise adjacent to or next to or over.

The terms “couple,” “coupled,” “couples,” “coupling,” and the like should be broadly understood and refer to connecting two or more elements or signals, electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable. For example, the recitation of a first electrical device being coupled to a second electrical device does not mean that the first electrical device cannot be removed (readily or otherwise) from, or that it is permanently connected to, the second electrical device.

### DETAILED DESCRIPTION OF EXAMPLES OF EMBODIMENTS

In a number of embodiments, a method of displaying data to a user includes: (a) displaying an ordered list, wherein the ordered list includes: (1) at least a first letter of a first entry of at least two entries of data; and (2) at least one character appended after the at least the first letter of the first entry of the at least two entries of the data, where the at least one character is absent from the first entry; (b) retrieving one or more second entries of the at least two entries of the data; and (c) displaying the one or more second entries of the at least two entries of the data.

In other embodiments, a method of displaying a set of entries from a database includes: (a) retrieving information about the set of entries, wherein the information about the set of entries includes at least a first letter from a first portion of the set of entries; (b) appending at least one character to each entry in a first part of the first portion of the set of entries to form scrolling data where the at least one character is absent from that entry in the first part of the set of entries; (c) displaying the scrolling data in response to user input; (d) retrieving at least one entry of the set of entries; and (e) displaying the at least one entry of the set of entries.

In yet another embodiment, an electrical device configured to display data to a user including: (a) a display unit; (b) a display control mechanism configured to wirelessly receive at least a first letter of each entry of a first portion of the two or more entries of the data from the database; and (c) a character module configured to provide to the display control mechanism at least one character. The display control mechanism is configured to create scrolling data by appending the at least one character to the at least the first letter of each entry of the first portion of the two or more entries of the data, where the at least one character is absent from the first entry. Furthermore, the display unit is configured to display the scrolling data in response to input from the user.

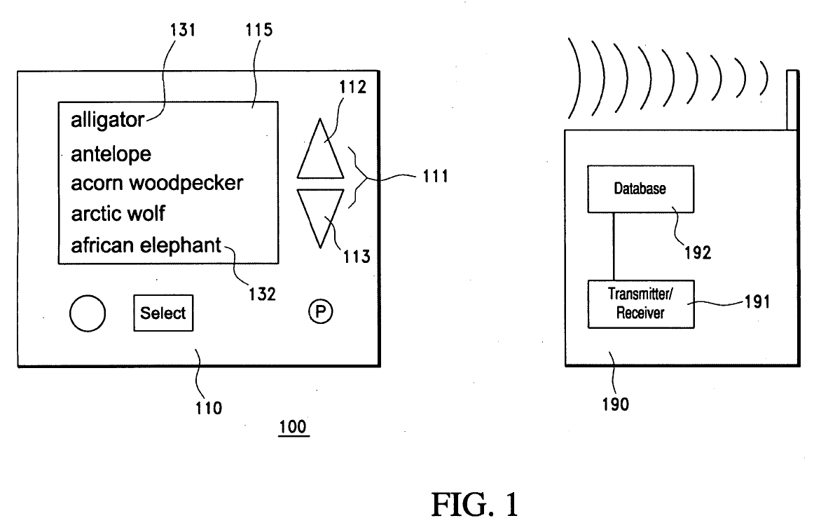

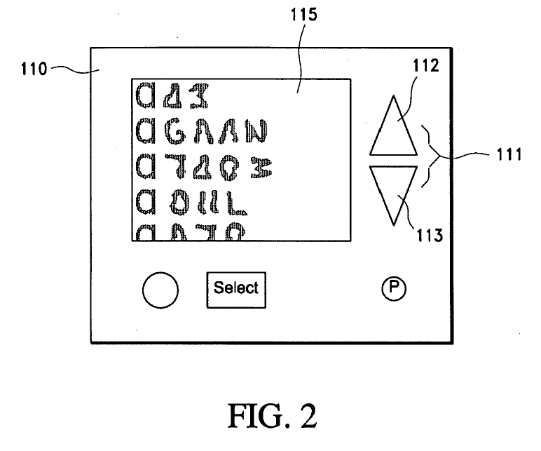

Turning to the drawings, FIG. 1 illustrates an overview of a system 100 for transmitting and displaying data, according to a first embodiment. FIG. 2 illustrates an electrical device 110 of system 100 while a user is scrolling through data, according to a first embodiment. System 100 and electrical device 110 are merely exemplary and are not limited to the embodiments presented herein. System 100 and electrical device 110 can be employed in many different embodiments or examples not specifically depicted or described herein.

In this embodiment, a master device 190 transmits data from a database 192 using transmitter/receiver 191 over a wireless network. Electrical device 110 can receive the data from master device 190 and displays the data on a display unit 115. A user of electrical device 110 can scroll through the entries (e.g., first entry 131, alligator and last entry 132, african elephant) of the data displayed on display unit 115 using user controls 111 (e.g., buttons 112 and 113).

As shown in FIG. 2, in this embodiment, when the user quickly scrolls through the entries of the data, a portion of entries (e.g., the first letter of the entry or the first and second letter of the entry) can be displayed on display unit 115 along with one or more types of blurred, random non-English (or non-domestic language) characters appended to the end of the portion of the entry to give the appearance and perception to the user that the actual entries are being displayed and scrolled-through. Only displaying a portion of the entries along with the blurred, random non-English characters allows electrical device 110 to smoothly scroll through the entries without the jerky or intermittent scrolling of other electrical devices. Accordingly, electrical device 110 provides the user with a more satisfying scrolling experience compared to the jerky or intermittent scrolling of other electrical devices.

In a more detailed description of an embodiment, an electrical device could be configured to display a list of songs titles of songs stored on an MP3 (MPEG-1 (Moving Picture Experts Group) Audio Layer 3) player (i.e., the master device). This electrical device could have a very small amount of memory to reduce the cost of manufacturing the electrical device. Furthermore, the wireless link between the electrical device and the MP3 player could be slow (e.g., a 576 kilobytes per second serial connection). In this situation, the electrical device would not be able to save all of the list of songs titles on the MP3 player in its memory and would not be able to download the song titles fast enough to keep up with a quick scroll through the list of song titles.

Using this embodiment, the electrical device could download the first letter of each song title and a random number of one or more different types of blurred characters could be appended to the first letter of each song title shown on the display unit, while the user is scrolling through the list of song titles. Because the list is being quickly scrolled across the display unit, the user would not be able to see that pseudo-entries were being displayed instead of the actual song titles. In other embodiments, instead of just displaying the first letter of each song title, the electrical device can show two or more letters of each song title. In some examples, the electrical device can display all the actual data it has access to.

Scrolling, as described herein, can be implemented to enable the user to scroll horizontally, vertically, or both directions. As used herein, scrolling is generically described in terms of moving forward and backward in data comprised of a set of entries. For horizontal scrolling, moving forward can be scrolling to the right, and moving backward can be scrolling to the left. For vertical scrolling, moving forward can be scrolling down, and moving backward can be scrolling up.

As used herein, the terms “entry,” “entries” and “set of entries” are used broadly to encompass any type of information that can be displayed to a user, including but not limited to text, graphics, and data. In some situations, a “set of entries” can include only one entry.

Electrical device 110 can be any type of electrical device that includes the capability to scroll through a set of entries on an attached or integrated display unit. For example, electrical device 110 can be a PDA (personal digital assistant), a Blackberry® device, a pager, a portable computer, a desktop computer, an MP3 player, a control device for another electrical device, a digital video recorder, a telephone, an electronic book reader, a GPS (global positioning system) navigation device, a CD (compact disk) player, or a CD-ROM (compact disk read only memory) player, a digital data storage device, or a remote control.

Master device 190 can be any type of electrical device that is configured to store a set of entries and capable of being coupled to electrical device 110 to transmit the set of entries to electrical device 110. For example, master device 190 can be a PDA, a Blackberry® device, a pager, a portable computer, a desktop computer, an MP3 player, a control device for another electrical device, a digital video recorder, a telephone, an electronic book reader, a GPS navigation device, a CD player, or a CD-ROM player, a digital data storage device, or a remote control. In the same or different embodiments, master device 190 can be a server or other data storage device accessed over a network (e.g., the Internet, cell phone network, or pager network).

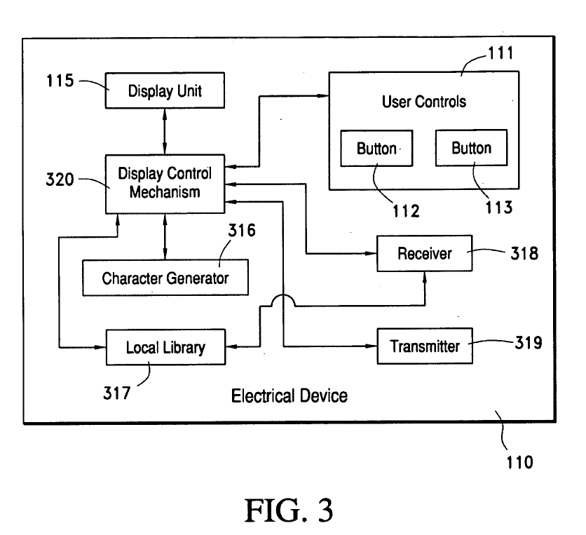

FIG. 3 is a block diagram illustrating an example of electrical device 110, according to the first embodiment. In some embodiments, electrical device 110 can be configured to display to a user data retrieved from database 192 in master device 190 (FIG. 1).

In various examples, electrical device 110 can include: (a) user controls 111; (b) display unit 115; (c) a character generator 316; (d) a local library 317; (e) a receiver 318; (f) a transmitter 319; and (g) display control mechanism 320. Display unit 115 can be a LCD (liquid crystal display), plasma, cathode ray tube, or another type of display.

User controls 111 can include a scrolling mechanism to allow a user to move forward and backward in data displayed on display unit 115. In the example illustrated in FIG. 1, user controls 111 include buttons 112 and 113. A user can press button 112 to move forward in the data and button 113 to move backward in the data. In other examples, user controls 111 can include more than two buttons, a scroll wheel, a track ball, a touchpad (separate from or integrated into display unit 115), or other scrolling mechanisms.

Character generator 316 can be configured to provide to display control mechanism 320 with characters. In some embodiments, the characters can include one or more types of blurred and/or illegible characters. In the same or different examples, the character(s) can be non-English (or non-Japanese, non-Chinese, non-German, non-French, non-Italian, etc.) characters. For example, character generator 316 can provide the blurred characters appended to the “a”s shown on display unit 115 in FIG. 2. In some embodiments, character generator 316 can provide the characters to display control mechanism 320 when a user is scrolling through the data. In the same or different embodiments, character generator 316 can provide the characters to display control mechanism 320 before the user begins scrolling.

In some examples, character generator 316 can randomly generated the characters. In other examples, character generator 316 can use a statistical model to generate the characters. For example, character generator 316 can use statistical models of the data (or a different data) to determine how many words contain each letter. Character generator 316 can approximate this statistical distribution of letter by providing blurred version of letters in proportion to their statistical distribution.

If it can't get the counts at first the system can use this statistical information to make its initial model of the data. As the system scrolls through the actual data and/or has time to query the dataset behind the users back it will come across the actual starting points in the data set for each letter and can update the model appropriately.

Receiver 318 can be electrically coupled to display control mechanism 320 and local library 317. In some embodiments, receiver 318 can be configured to wirelessly receive entries or a portion thereof from master device 190 (FIG. 1). In other embodiments, receiver 318 can be configured to receive data from master device 190 (FIG. 1) over a cable or wire.

Transmitter 319 can be electrically coupled to display control mechanism 320 and configured to transmit information from electrical device 110 to master device 190 (FIG. 1). In some examples, transmitter 319 can be configured to wirelessly transmit information to master device 190 (FIG. 1). In other embodiments, transmitter 319 can be configured to transmit information to master device 190 (FIG. 1) through a cable or wire. Transmitter 319 can also be coupled to user controls 111, or in a different embodiment, transmitter 319 can be coupled to user controls 111 and not be coupled to display control mechanism 320.

Local library 317 can be configured to store at least a portion of the data and other information. In one embodiment, receiver 318 can receive the data from master device 190 (FIG. 1) and transmit the data to local library 317 where the data is stored. In some examples, local library 317 can be memory. For example, local library 317 can be RAM. (random access memory), flash, or other types of memory.

In some examples, display control mechanism 320 is configured to control what is displayed on display unit 115. That is, display control mechanism 320 provides the data to be displayed to display unit 115. Display control mechanism 320 is also configured to create scrolling data by appending the at least one character to a portion of each entry during fast scrolling. Moreover, display control mechanism 320 is configured to provide the actual entries to be shown on display unit 115 when the user is not scrolling through the data.

Display control mechanism 320 can also wirelessly receive at least a first English character of each entry of a first portion of the two or more entries of the data from the database 192 in master device 190 (FIG. 1) through receiver 318.

In some embodiments, display control mechanism 320 and character generator 316 can be software executed on a CPU (central processing unit) (not shown) or other microprocessing units (e.g., a video chip). When electrical device 110 is running, program instructions stored in local library 317 can be executed by the CPU. A portion of the program instructions, stored on electrical device 110, can be suitable for carrying out the functionality of display control mechanism 320 and character generator 316.

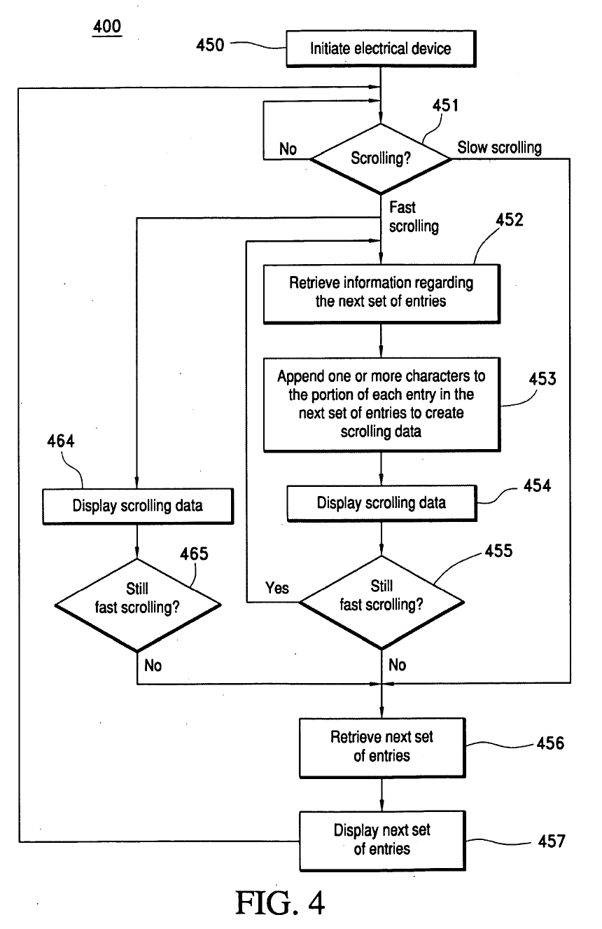

FIG. 4 illustrates a flow chart of an example of a method 400 of data retrieval and data display, according to the first embodiment. Method 400 can also be considered a method for displaying data from a database. Method 400 is merely illustrative of a technique for implementing the various aspects of certain embodiments described herein, and electrical device 110 (FIG. 3) and method 400 are not limited to the particular embodiments described herein, as numerous other embodiments are possible.

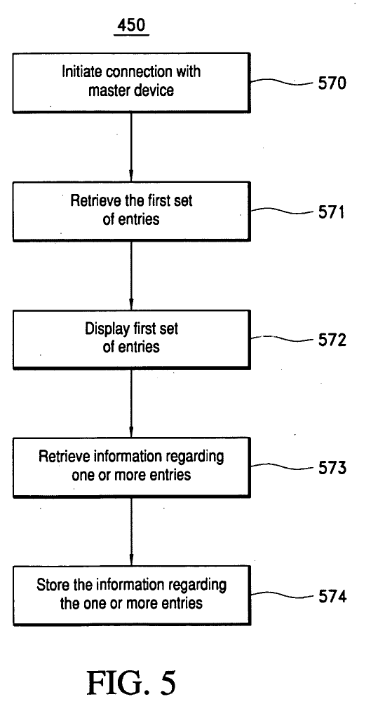

In the example illustrated in FIG. 4, a first activity of method 400 is an activity 450 of initiating or initializing electrical device 110 (FIG. 3). FIG. 5 illustrates a flow chart of an example of activity 450 of initiating electrical device electrical device 110 (FIG. 3), according to the first embodiment.

Referring to FIG. 5, the first procedure of activity 450 is a procedure 570 of initiating the connection with master device 190 (FIG. 1). In some examples, initiating the connection includes performing one or more handshaking and/or initiation routines with master device 190 (FIG. 1). If the connection between master device 190 (FIG. 1) and electrical device 110 (FIG. 3) is a wireless connection, procedure 570 can also include detecting a wireless signal from master device 190 (FIG. 1). In some embodiments, receiver 318 (FIG. 3) and/or display control mechanism 320 (FIG. 3) can perform the one or more handshaking and/or initiation routines, and/or wireless signal detection.

The next procedure of activity 450 is a procedure 571 of retrieving the first set of entries. As discussed above, the data stored in database 192 (FIG. 1) on master device 190 (FIG. 1) includes multiple entries. In some examples, the entries are stored as an ordered list (e.g., alphabetically, by date, or by size). In various embodiments, the first set of entries of the data can be retrieved from database 192 (FIG. 1). In some examples, the number of entries in the first set of entries is equal to the number of entries that can be displayed on display unit 115 (FIG. 1) at one time. In other embodiments, the number of entries in the first set of data is equal to two or more times the number of entries that can be displayed on display unit 115 (FIG. 1) at one time. In another example, the number of entries in the first set of entries is equal to the maximum number of entries that can be stored in local library 317 (FIG. 3) based on the amount of memory available or the amount of memory allocated to storing entries. In another example, the entries in the first set of data are the first five to ten entries (or another predetermined number of entries) for each letter of the alphabet. In other embodiments, the number of entries in the next set of entries can be arbitrarily set by the manufacturer of electrical device 110 (FIG. 1)

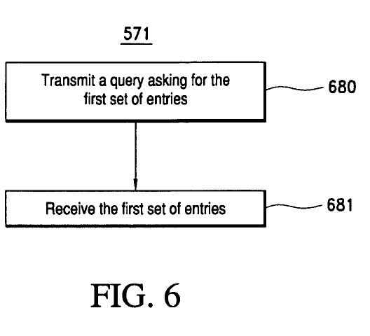

FIG. 6 illustrates a flow chart of an example of procedure 571 of retrieving the first set of entries in the data, according to the first embodiment. Referring to FIG. 6, the first process of procedure 571 is a process 680 of transmitting a query asking for the first set of entries. In one example, display control mechanism 320 (FIG. 3) communicates the query to transmitter 319 (FIG. 3), which transmits the query to master device 190 (FIG. 1).

The next process of procedure 571 is a process 681 of receiving the first set of entries from the master device 190 (FIG. 1). In one example, receiver 318 (FIG. 3) receives the first set of entries and communicates the first set of entries to: (1) display control mechanism 320 (FIG. 3); or (2) local library 317 (FIG. 3) for transmission to display control mechanism 320 (FIG. 3). After receiving the first set of entries, procedure 571 is complete, and the next procedure of activity 450 is procedure 572 (FIG. 5).

Referring again to FIG. 5, the next procedure of activity 450 is procedure 572 of displaying the first set of entries (or a portion of the first set of entries). In some embodiments, display control mechanism 320 (FIG. 3) causes the first set of entries to be displayed on display unit 115 (FIG. 1).

In some instances, instead of displaying the first set of entries, the first set of entries (or a portion of the first set of entries) can be stored in local library 317 (FIG. 3). For example, if more entries are retrieved than can be displayed on display unit 115 (FIG. 1) at one time, the non-displayed entries can be stored in local library 317. In another example, if the user is currently using another function of electrical device 110 (e.g. viewing a picture, listening to a music, or reading a email message) and the first set of data is not required, all of the first set of data can be stored in local library 317 (FIG. 3).

Subsequently, activity 450 continues with procedure 573 of retrieving information regarding one or more entries. In some embodiments, procedure 573 involves querying to determine the number of entries starting with each letter of the alphabet. For example, display control mechanism 320 (FIG. 3) queries database 192 (FIG. 1) in master device 190 (FIG. 1) to retrieve the number of entries starting with each letter of the alphabet.

In other examples, a part of one or more entries of the data is retrieved. In some embodiments, display control mechanism 320 (FIG. 3) queries database 192 (FIG. 1) in master device 190 (FIG. 1) to retrieve a part of one or more entries of the data. For example, display control mechanism 320 (FIG. 3) can query database 192 (FIG. 1) in master device 190 (FIG. 1) for at least the first two or three English characters of each of the one or more entries. In other examples, the portion of each entry can be the first letter in the entry. The procedure for retrieving the information in procedure 573 can be similar to retrieving the first set of entries of procedure 571.

The next procedure of activity 450 is a procedure 574 of storing the information regarding the one or more entries in local library 317 (FIG. 3). In one example, display control mechanism 320 (FIG. 3) communicates the information to local library 317 (FIG. 3).

In some examples, the stored information can be later used to generate statistical information about the entries to provide a better simulation of the data in subsequent scrolls through the entries. For example, display control mechanism 320 (FIG. 3) or character generator 316 (FIG. 3) can use the stored information to generate statistical information about the entries. In one example, display control mechanism 320 (FIG. 3) can determine the number of entries that start with each letter so that information does not have to be transferred again from master device 190 (FIG. 1). After procedure 574, activity 450 is complete, and the next activity of method 400 is an activity 451.

Referring again to FIG. 4, activity 451 of method 400 includes determining whether the user is scrolling though the entries. In some example, the user can be fast scrolling, slow scrolling, or not scrolling through the entries. If the user is not scrolling through the entries, display control mechanism 320 (FIG. 3) continues to check until the user begins to scroll.

Fast scrolling occurs when the user repeatedly or continually uses user controls 111 (FIG. 1) to scroll through the entries. That is, fast scrolling occurs when the user repeats or continuously presses button 112 or 113 (FIG. 1). In some examples, if the user holds down button 112 or 113 (FIG. 1), the user is fast scrolling through the entries. In alternative examples, fast scrolling occurs when the user continuously or repeatedly rotates a scroll wheel or a track ball.

Slow scrolling occurs when the user uses user controls 111 (FIG. 1) to slowly move through the data. That is, slow scrolling happens when the user presses button 112 or 113 (FIG. 1) once or repeatedly with pauses (e.g., one second) in between. In alternative examples, slow scrolling occurs when the user rotates a scroll wheel one click or slowly rotates the scroll wheel.

If the user is slow scrolling, the next activity of method 400 is an activity 456. Activity 456 of method 400 is an activity of retrieving the next set of entries. Which entries and how many entries that are retrieved in this activity depends on how many times the user presses buttons 112 and 113 (FIG. 1) If the user presses button 112 (FIG. 1) once, the entry in the data before first entry 131 (FIG. 1) currently displayed on display unit 115 (FIG. 1) is retrieved. If the user presses button 113 (FIG. 1) once, the entry after last entry 132 (FIG. 1) is retrieved. If the user presses button 112 or 113 (FIG. 1) multiple times, multiple entries are retrieved.

In some examples, the multiple entries are each retrieved separately. In other examples, the multiple entries are retrieved as a set. Retrieving the individual entry or a set of entries can be similar or identical to the retrieving the first set of entries of procedure 571 of FIG. 5. In alternative embodiments, if the user presses button 112 or 113 (FIG. 1) only once, multiple entries can be still be retrieved. In this example, if the user presses button 112 or 113 (FIG. 1) again, the new entry can be displayed immediately on display unit 115 (FIG. 1) without having to retrieve the entry.

After retrieving the entries, the next activity of method 400 is activity 457 of displaying the next set of entries. Displaying the entries can be similar or identical to procedure 572 of FIG. 5. After displaying the next set of entries, the next activity is activity 451 again of determining if the user is fast scrolling, slow scrolling, or not scrolling through the data.

Returning to activity 451, if the user is fast scrolling through the entries, the next procedure of method 400 after activity 451 is an activity 452 of retrieving the information regarding the next set of entries. The next set of entries can refer to the set of entries immediately before the entries currently displayed if the user is scrolling backwards in the data. The next set of entries can refer to the set of entries immediately after the entries currently displayed if the user is scrolling forward in the data.

In various examples, the number of entries in the next set of entries can be one or equal to the number of entries that can be displayed on display unit 115 (FIG. 1) at one time. In other embodiments, the number of entries in the next set of entries can be arbitrarily set by the manufacturer of electrical device 110 (FIG. 1)

In some examples, display control mechanism 320 (FIG. 3) retrieves the information regarding the next set of entries from local library 317 (FIG. 3). In examples where the entries are in alphabetical order and, in procedure 573, the number of entries beginning with each letter were retrieved, display control mechanism 320 (FIG. 3) can determine of the current position in the set of entries and what is the first letter of the next entry or set of entries.

For example, if the user is scrolling backward through the data and if the data includes seven entries beginning with the letter “a” and the third through seventh entries are currently displayed on display unit 115 (FIG. 1), the next set of entries also starts with the letter “a.”

If the user is scrolling forward through the data and if the third through seventh entries are currently displayed, the next entry does not start with the letter “a.” Accordingly, display control mechanism 320 (FIG. 3) retrieves from local library 317 (FIG. 3), the number of entries starting with the letter “b.” If one or more entries begin with the letter “b,” the next set of entries begins with the letter “b.” If no entries begin with the letter “b,” display control mechanism 320 (FIG. 3) repeats this procedure for the letter “c” and other letters if necessary. In the same or different example, the next set of entries can include one or more entries starting with “b” and one or more entries starting with another letter.

If during procedure 573 (FIG. 5), a part of one or more entries of the data was retrieved from database 192 (FIG. 1), the parts of the next set of entries is retrieved from local library 317 (FIG. 3). For example, display control mechanism 320 could retrieve the parts of the next set of entries from local library 317. In the same or a different embodiment, the portion of the entries retrieved from local library 317 (FIG. 3) could be the at least first English characters of each of the entries in the next set of entries.

In alternative embodiments, procedure 573 (FIG. 5) was omitted or skipped. In these embodiments, the first characters of the next set of entries are retrieved from database 192 (FIG. 1) in master device 190 (FIG. 1). The procedure to retrieve the first character of the next set of entries can be similar to the procedure described in relation to procedure 571 of FIG. 5. In some examples, the retrieved information can be later used to generate statistical information about the entries to provide a better simulation of the data in subsequent scrolls through the entries.

In additional to retrieving the first characters of the next set of entries, complete entries can be downloaded during procedure 573 (FIG. 5). For example, if all of the available bandwidth between electrical device 190 (FIG. 3) and mater device 190 (FIG. 1) is not needed to retrieving the first characters of the next set of entries, the remaining bandwidth can be used to retrieve the complete entries from another set of entries. That is, in some embodiments, in addition to retrieving the first characters of the next set of entries, a portion of the complete entries for a sequent set of entries can be retrieved. In this embodiments, if the user scrolls to the subsequent set of entries, one or more complete entries can be shown to the user, instead of just pseudo-entries. Intermixing real entries with pseudo-entries will improve the simulation of the data.

The next activity of method 400 is an activity 453 of appending one or more characters to the portion of each entry in the next set of entries to create an ordered list of scrolling data. For example, display unit 115 in FIG. 2 illustrates several examples of characters appended to the first character (“a”) of several entries. In some embodiments, the one or more characters appended are non-English and/or fictional characters. In the same or different embodiments, the number of characters and which characters are appended to the first one or more letters of the next entry can be randomly determined. Furthermore, in some embodiments, the one or more characters can be blurred and/or illegible characters. In other embodiments, one or more of the same non-English character is appended to the first (or first and second) characters of each displayed entry. In some examples, character generator 316 (FIG. 3) provides the characters to display control mechanism 320 (FIG. 3), which appends the characters to the portion of each entry in the next set of entries to create a pseudo-entry. In some embodiments, the portion of each entry in the next set of entries can also be blurred.

The subsequent activity of method 400 is an activity 454 of displaying the scrolling data. If the user is scrolling backward, the scrolling data is shown at the top of display unit 115 (FIG. 1) before first entry 131 (FIG. 1). If the user is scrolling forward, the scrolling data is shown at the bottom of display unit 115 (FIG. 1) after the last entry 132 (FIG. 1). The pseudo-data in the scrolling data is displayed on display unit 115 (FIG. 1) one pseudo-entry at a time with a lapse of only a very short period of time (e.g., a fraction of a second) before the next entry of the scrolling data is displayed and one of the current entries or pseudo-entries is removed and the other entries or pseudo-entries' positions are shifted forward or backward.

The scrolling data appears to the user to be blurred and unfamiliar to the user because of the motion of the scrolling data. Accordingly, displaying the first letter or letters of the entries along with the added characters creates the perception and appearance to the user that he is scrolling through the actual entries in the data, not the pseudo-entries of the scrolling data. Additionally, including the first letter (or letters) of each entry in the pseudo-entries allows the user to identify the current position in the data. For example, if the user can see the first letter in each entry is a “d,” he knows that he is scrolling through the portion of the data that starts with “d,” even if he cannot recognize the rest of the characters displayed.

In some examples, the scrolling data includes all information retrieved about the entries. Accordingly, if electrical device 110 (FIG. 1) has received information (e.g. the whole entry or four letters of the entry) about a subset of the entries, all of the information available about the entry will be displayed.

After displaying the scrolling data, the next activity is an activity 455 of determining if the user is still fast scrolling. If the user is still fast scrolling, the next activity of method 400 is activity 452 of retrieving the information about the next set of entries. If the user has stopped fast scrolling, the next activity is activity 456 of retrieving the next set of entries.

In a different embodiment of method 400, if activity 451 determines that the user is fast scrolling, then method 400 continues with an activity 464, instead of activity 452. In this different embodiment, activity 464 displays the scrolling data. As an example of activity 464, display unit 115 (FIG. 1) displays a scrolling list of pseudo-“a” entries, each having one or more of the same or different non-English characters and/or blurred characters appended after the first letter “a” in each entry. Display unit 115 (FIG. 1) can display this scrolling list of pseudo-“a” entries for a predetermined period of time such as, for example, 0.25 to 0.5 seconds. In this embodiment, the length of time that display unit 115 (FIG. 1) displays the list of pseudo-“a” entries can be independent of the quantity of actual “a” entries in the data from database 192 (FIG. 1).

Continuing with this different embodiment of method 400, method 400 continues with an activity 465, which determines if the user is still fast scrolling. If so, method 400 continues by repeating activity 464 to display the scrolling data. This time, however, activity 464 displays a scrolling list of pseudo-“b” entries, each having one or more of the same or different non-English characters and/or blurred characters appended after the first letter “b” in each entry. Display unit 115 (FIG. 1) can display this list of pseudo-“b” entries for the same predetermined period of time or for a different predetermined period of time. Similar to the first time that activity 464 was performed, the length of time that display unit 115 (FIG. 1) displays the list of pseudo-“b” entries can be independent of the quantity of actual “b” entries in the data from database 192 (FIG. 1).

This different embodiment of method 400 continues in this repetitive manner until activity 465 determines that the user is no longer fast scrolling. When this situation occurs, method 400 continues with activity 456, which determines the set of pseudo-entries that display unit 115 (FIG. 1) was displaying in the last occurrence of activity 464. For example, if display unit 115 (FIG. 1) was most recently displaying the pseudo-“r” entries, then activity 456 retrieves at least a portion of the actual “r” set of entries from database 192 (FIG. 1), and subsequently, activity 457 displays that portion of the actual “r” set of entries; In one embodiment, activity 456 retrieves the first portion of the actual “r” set of entries, and in another embodiment, activity 456 retrieves the middle or end portion of the actual “r” set of entries.

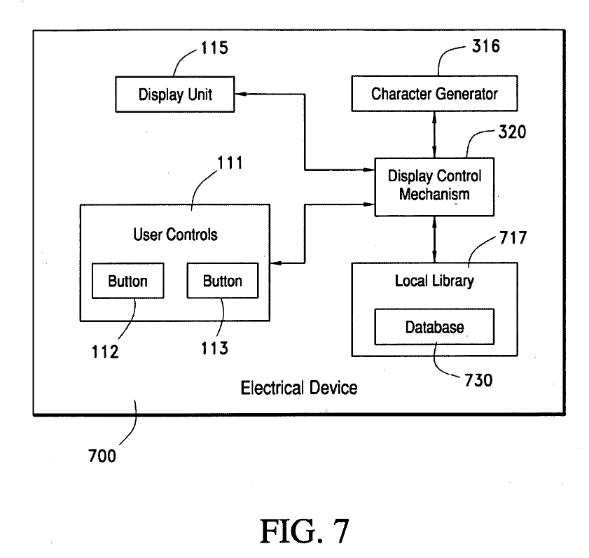

Turning to another embodiment, FIG. 7 illustrates an overview of an electrical device 700 for displaying data, according to a second embodiment. Electrical device 700 can include: (a) display unit 115; (b) user controls 111; (c) display control mechanism 320; (e) character generator 316; and (d) local library 717 coupled to display control mechanism 320. In this embodiment, local library 717 stores database 730, instead of having the database stored on a separate master device 190 (FIG. 1). In some examples, local library 717 can be considered the master device.

In these embodiments, entries of the data (or portions thereof) can be provided to display control mechanism 320 directly from local library 717. When a user fast scrolls through entries in the data, display control mechanism 320 provides the same scrolling data with pseudo-entries to display unit 115. Providing the scrolling data with pseudo-entries frees system resources (e.g., CPU (central processing unit) time or system bus capacity) on electrical device 700 for other tasks.

In the same or different embodiments, display control mechanism 320 can have dedicated memory that can be used to stored entries or portions thereof. For example, electrical device 110 could be a computer and display control mechanism 320 and character generator 316 can be part of a graphic card, video card, or video chip in the computer. The graphics or video card could include separate memory that could be used by display control mechanism 320.

Although the invention has been described with reference to specific embodiments, it will be understood by those skilled in the art that various changes may be made without departing from the spirit or scope of the invention. For example, local library 317 (FIG. 3) or 717 (FIG. 7) does not have to be part of electrical device 110 (FIG. 1) or 700 (FIG. 7), respectively. Local library 317 (FIG. 3) or 717 (FIG. 7) could be a memory component coupled to electrical device 110 (FIG. 1) or 700 (FIG. 7), respectively. Additional examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. To one of ordinary skill in the art, it will be readily apparent that the case and method of use discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of displaying data to a user, the data comprises at least two entries, the method comprising:
displaying an ordered list, wherein the ordered list comprises:
at least a first letter of a first entry of the at least two entries of the data; and
at least one character appended after the at least the first letter of the first entry of the at least two entries of the data, where the at least one character is absent from the first entry;
retrieving one or more second entries of the at least two entries of the data; and
displaying the one or more second entries of the at least two entries of the data.

2. The method of claim 1, wherein:
the first entry of the at least two entries of the data is different than the one or more second entries of the at least two entries of the data.

3. The method of claim 1 further comprising:
before displaying the ordered list, retrieving the at least the first letter of the first entry of the at least two entries of the data.

4. The method of claim 1 further comprising:
before displaying the ordered list, appending the at least one character to the at least the first letter of the first entry of the at least two entries of the data.

5. The method of claim 1 further comprising:
before displaying the one or more second entries of the at least two entries of the data, storing the one or more second entries of the at least two entries of the data in a local memory, wherein:
retrieving the one or more second entries of the at least two entries comprises:
retrieving the one or more second entries of the at least two entries of the data from the local memory.

6. The method of claim 1 wherein:
retrieving the one or more second entries of the at least two entries comprises:
wirelessly retrieving the one or more second entries of the at least two entries of the data.

7. The method of claim 1 further comprising:
before displaying the one or more second entries of the at least two entries of the data, receiving a user input; and
no longer receiving the user input before retrieving one or more second entries of the at least two entries of the data.

8. The method of claim 1, wherein:
displaying the ordered list comprises:
displaying the ordered list in response to user input.

9. The method of claim 1, wherein:
displaying the ordered list comprises:
displaying the ordered list to create an appearance of scrolling through the at least two entries of the data.

10. The method of claim 1, wherein:
a number of the at least one character appended after the at least the first letter of the first entry of the at least two entries of the data is random.

11. The method of claim 1, wherein:
the at least one character is randomly selected.

12. The method of claim 1, wherein:
the at least one character is at least one non-English character.

13. The method claim 1, wherein:
the at least one character is at least one blurred English character.

14. The method of claim 1, wherein:
each of the at least one character is identical to each other.

15. The method of claim 1, further comprising:
before displaying the ordered list, querying to determine a number of entries of the at least two entries of the data for each letter of the alphabet.

16. A method of displaying a set of entries from a database, the method comprising:
retrieving information about the set of entries, wherein the information about the set of entries comprises:
at least a first letter from a first portion of the set of entries;
appending at least one character to each entry in a first part of the first portion of the set of entries to form scrolling data, where the at least one character is absent from the entry in the first part of the set of entries;
displaying the scrolling data in response to user input;
retrieving at least one entry of the set of entries; and
displaying the at least one entry of the set of entries.

17. The method of claim 16, wherein:
retrieving the at least one entry of the set of entries comprises:
wirelessly retrieving the at least one entry of the set of entries from the database.

18. The method of claim 16, further comprising:
retrieving the information about the set of entries comprises:
querying the database for the first letter of each entry of the first portion of the set of entries.

19. The method of claim 16, wherein:
the at least one character comprises at least one blurred, illegible, non-English character.

20. The method of claim 16, wherein:
the at least one character comprises at least one random fictional character.

21. An electrical device configured to display data to a user, the data comprising two or more entries and retrieved from a database, the electrical device comprising:
a display unit;
a display control mechanism configured to wirelessly receive at least a first letter of each entry of a first portion of the two or more entries of the data from the database; and
a character module configured to provide to the display control mechanism at least one character,
wherein:
the display control mechanism is configured to create scrolling data by appending the at least one character to the at least the first letter of each entry of the first portion of the two or more entries of the data, where the at least one character is absent from the entry of the first portion of the two or more entries of the data; and
the display unit is configured to display the scrolling data in response to input from the user.

22. The device of claim 21, further comprising:
a library configured to store at least a second portion of the data,
wherein:
the display control mechanism is configured to provide the second portion of the two or more entries of the data to the display unit when the display control mechanism is no longer receiving input from the user.

23. The device of claim 21, further comprising:
a receiver electrically coupled to the display control mechanism and configured to wirelessly receive the at least the first letter of each entry of the first portion of the two or more entries of the data from the database.

24. The device of claim 21, further comprising:
a wireless transmitter coupled to the display control mechanism.

25. The device of claim 21, wherein:
the at least one character comprises at least one blurred, illegible, non-English character.
